(19) United States
(12) Patent Application Publication
(10) Pub. No.: US 2023/0202160 A1
(43) Pub. Date: Jun. 29, 2023

(54) METHOD OF DISASSEMBLING COMPOSITE MATERIAL AND COMPOSITE MATERIAL ITSELF

(71) Applicant: HONDA MOTOR CO., LTD., Tokyo (JP)

(72) Inventors: Satoshi OYAMA, Saitama (JP); Daisuke YAMAMOTO, Saitama (JP)

(21) Appl. No.: 18/146,388

(22) Filed: Dec. 26, 2022

(30) Foreign Application Priority Data
Dec. 28, 2021 (JP) 2021-214961

(51) Int. Cl. B32B 43/00; C09J 5/00

(52) U.S. Cl. CPC B32B 43/006; C09J 5/00

(57) ABSTRACT

The method controls a discharging gap suitably and easily, effectively damages an adhesive which is an insulator by a shock wave generated in a discharging gap, and disassembles the composite material into conductors. The method of disassembling the composite material includes: a protrusion formation step S1 of forming an elastic protrusion in a predefined part of a first conductor; a composite material formation step S2 of applying an insulator on a surface of the first conductor on which the protrusion stands and bonding or joining the first conductor and a second conductor facing a protruding end of the protrusion with the insulator to form a composite material 1; and a separation step of applying an electric pulse between the first conductor and the second conductor to damage the insulator, thereby separating the first conductor and the second conductor from each other.

This application is based on and claims the benefit of priority from Japanese Patent Application No. 2021-214961, filed on 28 Dec. 2021, the content of which is incorporated herein by reference.

### BACKGROUND OF THE INVENTION

### Field of the Invention

The present invention relates to a method of disassembling a composite material and a composite material itself.

### Related Art

A method of assembling a vehicle body including bonding or joining parts of the vehicle body with an adhesive is becoming more popular. This method contributes to weight reduction of the vehicle body, and shows signs of market penetration both domestically and internationally. There is also a movement to disassemble a scrapped vehicle body into components for reuse or recycling, if possible. For example, Patent Document 1 proposes a vehicle body component produced by bonding or joining parts into a composite material with an adhesive. In this composite material, a heating element is embedded in advance in an adhesive layer. When the heating element is energized, the adhesive layer is heated, softened, and degraded or melted. This is considered to achieve easy disassembly of the composite material. Another proposal by Patent Document 2, for example, is related to an improvement of a method of using an electric pulse to disassemble an object obtained by bonding or joining an insulator and a conductor.
Patent Document 1: Japanese Unexamined Patent Application, Publication No. 2021-6724
Patent Document 2: Japanese Unexamined Patent Application, Publication No. 2020-69454

### SUMMARY OF THE INVENTION

The technique of Patent Document 1 involves great difficulties in selecting the route of the heating element embedded in advance in the adhesive layer and selecting the specification of the heating element. The technique of Patent Document 2 can be applied to decomposing the adhesive layer, and the composite material can be disassembled using discharge produced by the electric pulse without using the heating element. However, the technique of Patent Document 2 requires suitable control of a discharging gap in order to produce the discharge that generates a shock wave sufficient to damage the insulator. In particular, if the composite material to be disassembled is long, it is extremely difficult to suitably maintain the discharging gap over the whole part of the composite material.

An object of the present invention is to provide a method of disassembling a composite material and a composite material itself. The method controls a discharging gap suitably and easily, effectively damages an adhesive which is an insulator by a shock wave generated in a discharging gap, and disassembles the composite material into conductors. Disassembling a composite material obtained by bonding or joining multiple parts with an adhesive and collecting the parts in a reusable or recyclable form require less production of new parts. This contributes to a reduction in environmental load, such as a reduction in carbon dioxide emissions.

In aspect (1) of the present invention, a method of disassembling a composite material includes: a protrusion formation step (e.g., a protrusion formation step S1 described later) of forming an elastic protrusion (e.g., a protrusion 10 described later) in a predefined part of a first conductor (e.g., a first conductor 7 described later); a composite material formation step (e.g., a composite material formation step S2 described later) of applying an insulator (e.g., an insulator 9 described later) to a surface of the first conductor on which the protrusion stands and bonding or joining the first conductor and a second conductor (e.g., a second conductor 8 described later) facing a protruding end (e.g., a protruding end 101 described later) of the protrusion with the insulator to form a composite material (e.g., a composite material 1 described later); and a separation step (e.g., a separation step S3 described later) of applying an electric pulse between the first conductor and the second conductor to damage the insulator, thereby separating the first conductor and the second conductor from each other.

(2) The method of aspect (1), wherein the protrusion is formed so as to widen from the protruding end toward a proximal end (e.g., a proximal end 102 described later) in the protrusion formation step.

(3) The method of aspect (1) or (2), wherein the composite material formation step includes a contacting step (e.g., a contacting step S221 described later) of bringing the protruding end (e.g., a protruding end 101 described later) of the protrusion into contact with an insulating film (e.g., an insulating film 15 described later) formed on a surface of a conductor used as the second conductor.

(4) A composite material (a composite material 1 described later) disassembled by an electric pulse, the composite material including: an elastic protrusion (e.g., a protrusion 10 described later) formed on at least one of a first conductor (e.g., a first conductor 7 described later) or a second conductor (e.g., a second conductor 8 described later) to extend from its proximal end (e.g., a proximal end 102) to protruding end (e.g., a protruding end 101); and an insulator (e.g., an insulator 9 described later) that is applied to part of the first or second conductor on which the protrusion is formed and bonds or joins the first conductor and the second conductor.

(5) The composite material of aspect (4), wherein the protrusion widens from the protruding end toward the proximal end.

(6) The composite material of aspect (4) or (5), further including: an insulating film (e.g., an insulating film 15 described later) that is formed on at least the other of the first conductor or the second conductor and makes contact with the protruding end of the protrusion.

(7) A method of disassembling a composite material (e.g., a composite material 1 described later) including a first conductor (e.g., a first conductor 7 described later) having an elastic protrusion (e.g., a protrusion 10 described later) formed in a predefined part and a second conductor facing a protruding end (e.g., a protruding end 101 described later) of the protrusion, the first conductor and the second conductor being bonded or joined with a coating layer of an insulator (e.g., an insulator 9 described later) provided on a surface of the first conductor on which the protrusion stands, the method including: a connection step (e.g., a connection step S31 described later) of electrically connecting the first conductor and the second conductor to a predetermined electric pulse source (e.g., a high voltage pulse generator 3 described later); and a separation step (e.g., a damage/separation step S32 described later) of applying an electric pulse between the first conductor and the second conductor electrically connected to the electric pulse source in the connection step to generate a shock wave of a dielectric breakdown current in a discharging gap between the protruding end of the protrusion and the second conductor, thereby damaging the insulator to separate the first conductor and the second conductor from each other.

(8) The method of aspect (7), wherein the protrusion widens from the protruding end toward a proximal end (e.g., a proximal end 102 described later).

(9) The method of aspect (7) or (8), wherein an insulating film (e.g., an insulating film 15 described later) is formed on the second conductor and makes contact with the protrusion.

In the method of aspect (1), even if the composite material is long and has multiple protrusions along its length, the protrusions, which are elastic, maintain a suitable discharging gap between each of the protrusions and the corresponding first or second conductor. When the shock wave of the dielectric breakdown current in the maintained discharging gap is uniformly generated at the protrusions in the insulator, the insulator is effectively broken, and the conductors constituting the composite material can be separated from each other. Disassembling a composite material obtained by bonding or joining multiple parts with an adhesive and collecting the parts in a reusable or recyclable form require less production of new parts. This contributes to a reduction in environmental load, such as a reduction in carbon dioxide emissions.

In the method of aspect (2), the protrusion is formed to be widened from the protruding end toward the proximal end in the protrusion formation step. This protrusion has high elasticity that keeps the protrusion standing up at the proximal end, advantageously contributing to the control of the discharging gap. Further, the protruding end in a tapered shape easily causes the dielectric breakdown between the protruding end and the corresponding conductor.

In the method of aspect (3), the insulating film forms the discharging gap between the protruding end of the protrusion and the second conductor. Thus, even if the composite material has multiple protrusions, the discharging gap between each of the protrusions and the corresponding first or second conductor is suitably controlled as the thickness of the insulating film.

In the composite material of aspect (4), even if the composite material is long and has multiple protrusions along its length, the protrusions, which are elastic, maintain a suitable and uniform discharging gap between each of the protrusions and the corresponding first or second conductor. When the shock wave of the dielectric breakdown current in the maintained discharging gap is uniformly generated at the protrusions in the insulator, the insulator is effectively broken, and the conductors constituting the composite material can be separated from each other. Disassembling a composite material obtained by bonding or joining multiple parts with an adhesive and collecting the parts in a reusable or recyclable form require less production of new parts. This contributes to a reduction in environmental load, such as a reduction in carbon dioxide emissions.

In the composite material of aspect (5), the protrusion is widened from the protruding end toward the proximal end. This protrusion has high elasticity that keeps the protrusion standing up at the proximal end, advantageously contributing to the control of the discharging gap. Further, the protruding end in a tapered shape easily causes the dielectric breakdown between the protruding end and the corresponding conductor.

In the composite material of aspect (6), the insulating film forms the discharging gap between the protruding end of the protrusion and at least one of the first or second conductor in contact with the protruding end. Thus, the discharging gap can be suitably controlled as the thickness of the insulating film.

In the method of aspect (7), even if the composite material is long and has multiple protrusions along its length, the protrusions, which are elastic, maintain a suitable discharge gap between each of the protrusions and the corresponding first or second conductor. When the shock wave of the dielectric breakdown current in the maintained discharging gap is uniformly generated at the protrusions in the insulator, the insulator is effectively broken, and the conductors constituting the composite material can be separated from each other. Disassembling a composite material obtained by bonding or joining multiple parts with an adhesive and collecting the parts in a reusable or recyclable form require less production of new parts. This contributes to a reduction in environmental load, such as a reduction in carbon dioxide emissions.

In the method of aspect (8), the protrusion is widened from the protruding end toward the proximal end. This protrusion has high elasticity that keeps the protrusion standing up at the proximal end, advantageously contributing to the control of the discharging gap. Further, the protruding end in a tapered shape easily causes the dielectric breakdown between the protruding end and the corresponding conductor.

In the method of aspect (9), the insulating film forms the discharging gap between the protruding end of the protrusion and the second conductor. Thus, the discharging gap can be suitably controlled as the thickness of the insulating film.

### BRIEF DESCRIPTION OF THE DRAWINGS

FIG. 1 is a schematic diagram illustrating the present invention;

FIG. 2 is a view illustrating some steps according to an embodiment of the present invention;

FIG. 3 is an enlarged view illustrating disassembly of a composite material obtained by the steps of FIG. 2 with a device of FIG. 1;

FIG. 4 is a schematic view illustrating the whole steps according to the embodiment of the present invention;

FIG. 5 is a view theoretically illustrating a dielectric breakdown path generated in the implementation of the present invention;

FIG. 6 is a view theoretically illustrating a dielectric breakdown path generated in the implementation of the present invention;

FIG. 7 is a view theoretically illustrating a dielectric breakdown path generated in the implementation of the present invention;

FIG. 8 is a view theoretically illustrating a dielectric breakdown path generated in the implementation of the present invention;

FIG. 9 is a schematic diagram illustrating another example of an embodiment of the present invention;

FIG. 10 is a schematic diagram illustrating another example of the embodiment of the present invention;

FIG. 11 is a schematic diagram illustrating another example of the embodiment of the present invention;

FIG. 12 is a view illustrating another example of a protrusion formation step according to the embodiment of the present invention; and

FIG. 13 is a table showing a correlation between the form of an adhesive used for forming a composite material as an embodiment of the present invention and a shock wave generated.

### DETAILED DESCRIPTION OF THE INVENTION

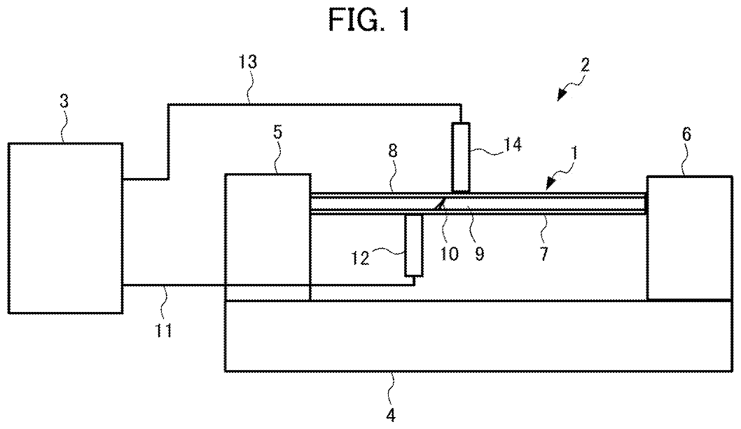

FIG. 1 is a schematic diagram illustrating the present invention. The present invention relates to a method of disassembling a composite material 1 obtained by bonding or joining conductors such as steel plates for automobiles with an adhesive serving as an insulator by application of an electric pulse, and a composite material suitable for the method. FIG. 1 is a view schematically illustrating part of an embodiment of the present invention. In FIG. 1, a reference numeral 1 denotes a composite material. A high voltage pulse generator 3 applies a high voltage pulse between top and bottom surfaces of the composite material 1 held by a holding device 2.

The holding device 2 has a stable holder 5 and a movable holder 6 that are provided on a base 4, and holds one end of the composite material 1 with the stable holder 5 and the other end with the movable holder 6 so that the composite material 1 is kept in a horizontal state. The composite material 1 includes a first conductor 7 on the bottom and a second conductor 8 on the top, which are bonded or joined together with an insulator 9 serving as an adhesive. The first conductor 7 has protrusions 10 protruding from a surface facing the second conductor 8 toward the second conductor 8. The first and second conductors 7 and 8 are steel plates for automobiles, for example. The multiple protrusions 10 are arranged at regular intervals over a surface of the first conductor 7. However, FIG. 1 just shows one of the protrusions for convenience's sake.

An end of a positive electrode cable 11 coming from the high voltage pulse generator 3 is connected to a positive electrode 12 that makes contact with a bottom surface of the first conductor 7. An end of a negative electrode cable 13 coming from the high voltage pulse generator 3 is connected to a negative electrode 14 that makes contact with a top surface of the second conductor 8. When the high voltage pulse generator 3 applies a high voltage between the first and second conductors 7 and 8, the polarity may be inverted. Specifically, a negative voltage may be applied to the first conductor 7, and a positive voltage may be applied to the second conductor 8.

In an embodiment of the present invention, a high voltage pulse, i.e., an electric pulse generated by the high voltage pulse generator 3, is applied between the positive electrode 12 and the negative electrode 14. This damages the insulator 9 serving as an adhesive with a shock wave generated by a dielectric breakdown current, thereby separating the first conductor 7 and the second conductor 8 from each other.

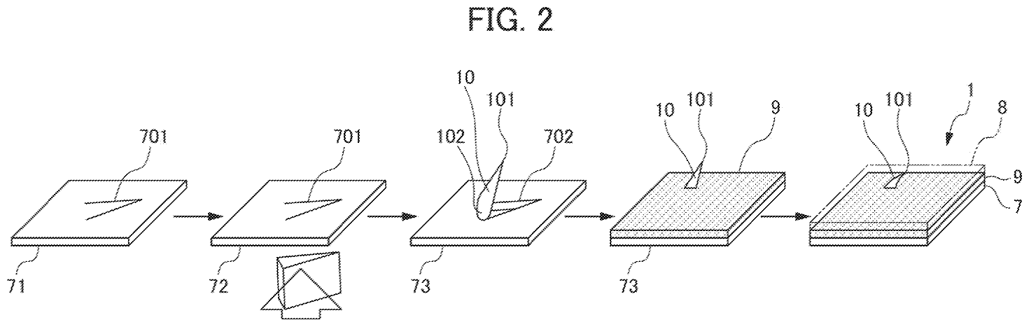

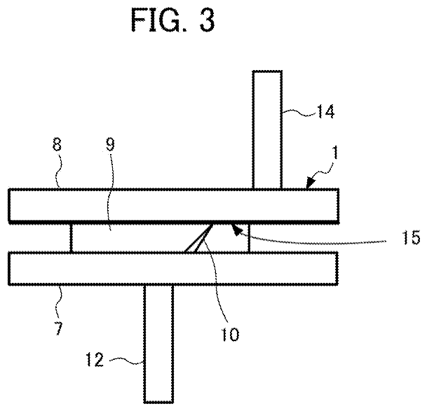

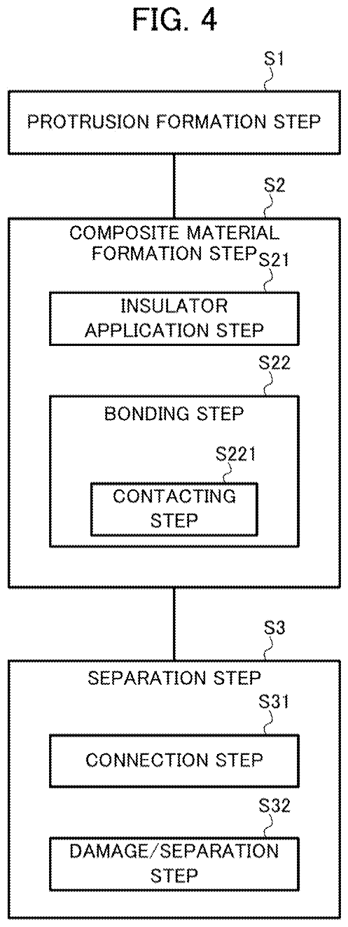

FIG. 2 is a view illustrating some steps according to the embodiment of the present invention. FIG. 3 is an enlarged view illustrating a preparatory phase of disassembly of the composite material obtained after the final step of FIG. 2 with the device of FIG. 1. FIG. 4 is a schematic view illustrating the whole steps according to the embodiment of the present invention. In FIG. 2, the process proceeds from the left to the right as indicated by arrows. In FIG. 3, the same components as those shown in FIG. 1 are indicated by the same reference numerals, and the description with reference to FIG. 1 is quoted.

For example, a plate-shaped blank, which is a steel plate for automobiles, is laser-processed to make a cut 701 penetrating the plate in a thickness direction, thereby obtaining a conductor plate 71 in the first form, i.e., a first-phase intermediate. When viewed in plan, the cut 701 has a shape similar to two sides of the protrusion 10 crossing at a protruding end 101.

Next, the conductor plate 71 in the first form is pressed into a conductor plate 72 in the second form, i.e., a second-phase intermediate. A portion of the conductor plate 72 in the second form between the two sides of the cut 701 is bent to stand up at a predetermined angle so that the bent portion corresponds to a proximal end 102 of the protrusion 10. Thus, a conductor plate 73 in the third form, i.e., a third-phase intermediate, is obtained.

The conductor plate 73 in the third form has the protrusion 10 obtained by making the cut 701 and raising the cut portion at a predetermined angle. The protrusion 10 formed by bending and raising the cut portion leaves a gap 702 in a portion of the conductor plate 73 from which the protrusion 10 stands up.

The conductor plate 71 in the first form is formed into the conductor plate 72 in the second form, and the protrusion 10 is formed to obtain the conductor plate 73 in the third form. In these steps, the protrusion 10 is formed to be widened from the protruding end 101 toward the proximal end 102. The steps of obtaining the conductor plate 73 in the third form are collectively referred to as a protrusion formation step S1 shown in FIG. 4.

The insulator 9 serving as an adhesive is applied to a surface of the conductor plate 73 in the third form on which the protrusion 10 stands. The step of applying the insulator 9 is an insulator application step S21 in a composite material formation step S2 shown in FIG. 4. When the insulator 9 is applied to the conductor plate 73 in the third form in the insulator application step S21, the protrusion 10, which is an elastic body, keeps standing up due to its elastic force. Specifically, the protruding end 101 of the protrusion 10 is not buried in the insulator 9 applied, but keeps protruding upward from a top surface of the insulator 9.

In a bonding step S22 in the composite material formation step S2 shown in FIG. 4, the conductor plate 73 in the third form which will be the first conductor 7 later and the second conductor 8 facing the protruding end 101 of the protrusion 10 are bonded or joined together with the insulator 9 to form the composite material 1. When the second conductor 8 is brought closer to the first conductor 7 for bonding or joining, the protrusion 10, which is the elastic body, flexibly bends at the protruding end 101 due to its elastic force, keeping the protruding end 101 and the second conductor 8 in contact with each other. In this case, the protruding end 101 of the protrusion 10 is brought into contact with an insulating film 15, for example, an electrodeposited film, formed on a surface of a conductor used as the second conductor 8 (see FIG. 3). Although not described in detail, when a thermosetting resin is used as the insulator 9, a heating step may be added to cure the resin.

As described above, the step of bringing the protruding end 101 of the protrusion 10 into contact with the insulating film 15 corresponds to a contacting step S221 in FIG. 4. In the contacting step S221, an insulating gap between the protruding end 101 of the protrusion 10 and the second conductor 8 is evenly controlled by the thickness of the electrodeposited insulating film 15.

This provides a uniform insulating gap between the protruding end 101 of each of the protrusions 10 dispersed over the surface of the first conductor 7 and the second conductor 8. Thus, in the composite material 1, dielectric breakdown occurs between the protruding ends 101 of the protrusions 10 and the second conductor 8 to produce an impact force that acts on the whole surface. This easily separates the first conductor 7 and the second conductor 8 from each other.

Specifically, in a connection step S31 in a separation step S3 shown in FIG. 4, the positive and negative electrodes 12 and 14 are brought into contact with the first and second conductors 7 and 8 to electrically connect the high voltage pulse generator 3 to the first and second conductors 7 and 8. Then, a high voltage pulse is applied to the conductors in a damage/separation step S32. As a result, the insulator 9 serving as an adhesive is broken by a shock wave generated by a dielectric breakdown current, thereby separating the first conductor 7 and the second conductor 8 from each other.

Various experiments performed by the inventors indicate that the shock wave that effectively damages the insulator 9 serving as an adhesive is generated even if the protruding ends 101 of the protrusions 10 are brought into contact with the second conductor 8 having no insulating film 15. This is presumably caused by the following phenomenon. First, at the instant when the high voltage pulse is applied between the first and second conductors 7 and 8, a current with an extremely high current density flows through a very narrow short-circuited portion between the sharp protruding end 101 of each protrusion 10 and the second conductor 8 in contact with each other. As a result, the protruding end 101 of the protrusion 10 in minimum contact with the second conductor 8 is instantly molten by abruptly generated Joule heat, producing a gap that effectively functions as a discharging gap. The gap thus generated is maintained by the insulator 9 that is an adhesive not broken yet. However, dielectric breakdown occurs in the gap due to continuous application of the high voltage pulse to generate a shock wave. This shock wave presumably damages the insulator 9 and separates the first conductor 7 and the second conductor 8 from each other.

The dielectric breakdown, which is a well-known phenomenon, will be briefly described below. When a high voltage is applied between positive and negative electrodes facing each other across a gap, electrons originally present in the gap start to move toward the positive electrode. Cations start to move toward the negative electrode. At this time, the electrons collide at high speed with molecules floating in the gap, releasing electrons from the floating molecules. The released electrons release more electrons from the other floating molecules to cause an electron avalanche. As a result, the dielectric breakdown occurs in the gap.

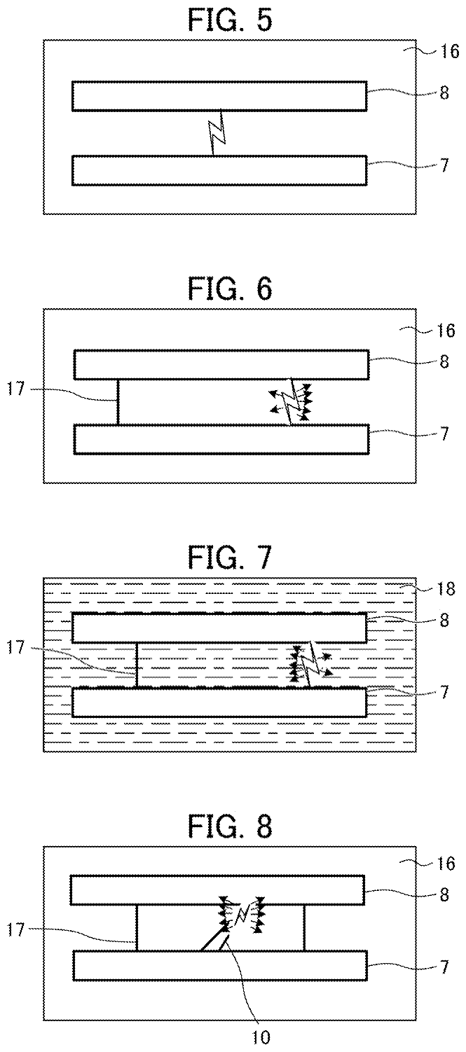

FIGS. 5 to 8 are views theoretically illustrating a dielectric breakdown path generated in the implementation of the present invention. In FIGS. 5 to 8, like reference numerals designate identical or corresponding components. As shown in FIG. 5, dielectric breakdown occurs when a voltage between the first and second conductors 7 and 8 in the air 16 reaches 3 KV/mm or more, which is a dielectric breakdown strength.

When an insulator 17 is sandwiched between the first and second conductors 7 and 8 as shown in FIG. 6, dielectric breakdown occurs when the voltage between the first and second conductors 7 and 8 reaches, for example, 40 KV/mm or more, which is a dielectric breakdown strength of the insulator 17. In the example of FIG. 6, the first and second conductors 7 and 8 and the insulator 17 are placed in the air 16. The current of the dielectric breakdown flows along the surface of the insulator 17 facing the air 16 because the air 16 has a lower dielectric strength than the insulator 17. For this reason, inputted energy is consumed by the air 16 and does not contribute to the damage of the insulator 17.

FIG. 7 shows that the first and second conductors 7 and 8 sandwiching the insulator 17 as shown in FIG. 6 are submerged in water 18. In the example of FIG. 7, most of the shock wave generated by the energy, which is consumed by the air 16 in the example of FIG. 6, acts on the insulator 17 to damage the insulator 17 because the water 18 has a higher dielectric strength than the air 16.

On the other hand, when the protrusion 10 is provided for the first conductor 7 as in the embodiment of the present invention shown in FIG. 8, the dielectric breakdown easily occurs between the tip end of the protrusion 10 and the second conductor 8. Further, the energy is not consumed by the air 16, and most of the energy contributes to the damage of the insulator 17. That is, in the state shown in FIG. 8, the shock wave generated by the dielectric breakdown effectively damages the insulator 17 placed in the air 16.

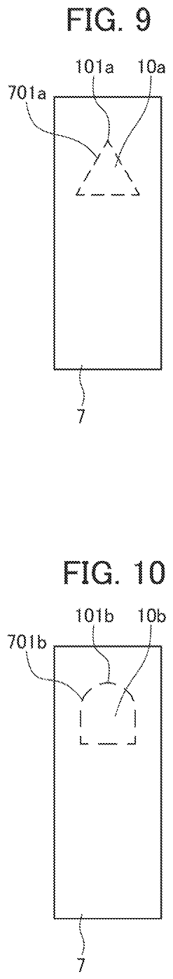

FIGS. 9 to 11 are views illustrating other examples of the protrusion provided for the first conductor of the embodiment of the present invention. In each of FIGS. 9 to 11, the outer shape of the protrusion is drawn with a dashed line. The protrusion is formed by making a cut in a steel plate which will be the first conductor 7 to penetrate the steel plate in the thickness direction and raising the cut portion up.

In the example of FIG. 9, a cut 701a is made in a steel plate which will be the first conductor 7, and a portion corresponding to a protruding end 101a is raised up to obtain a protrusion 10a in an almost regular triangle shape. The protruding end 101a is brought into contact with the insulating film 15 of the second conductor 8 as shown in FIG. 3.

In the example of FIG. 10, a cut 701b is made in a steel plate which will be the first conductor 7, and an arc-shaped portion corresponding to a protruding end 101b is raised up to form a protrusion 10b. The protruding end 101b is brought into contact with the insulating film 15 of the second conductor 8 as shown in FIG. 3. Also in this case, the protrusion 10b has a portion that widens from the protruding end 101b toward the proximal end as shown in the drawing.

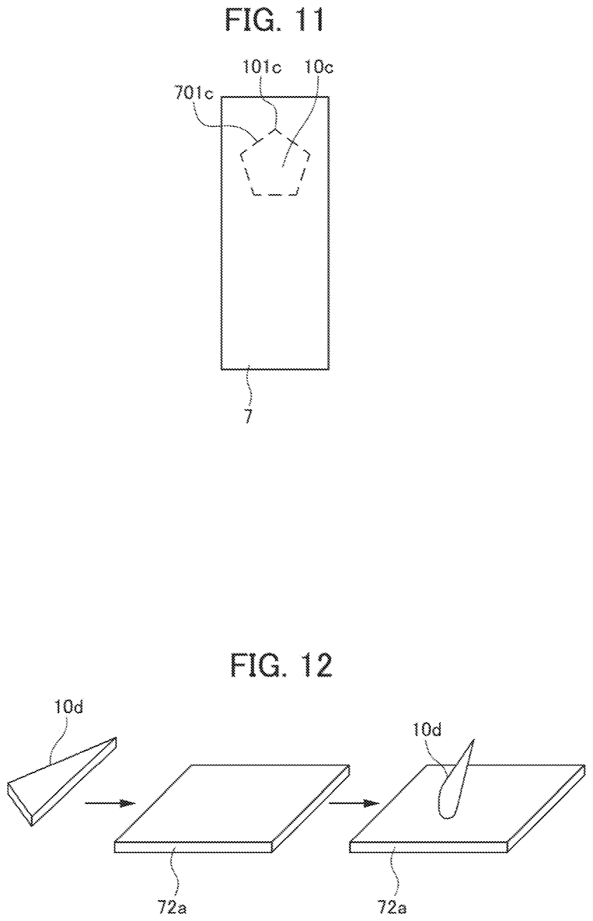

In the example of FIG. 11, a cut 701c is made in a steel plate which will be the first conductor 7, and a portion corresponding to a protruding end 101c is raised up to form a protrusion 10c in an almost regular pentagon shape. The protruding end 101c is brought into contact with the insulating film 15 of the second conductor 8 as shown in FIG. 3. Also in this case, the protrusion 10c has a portion that widens from the protruding end 101c toward the proximal end as shown in the drawing.

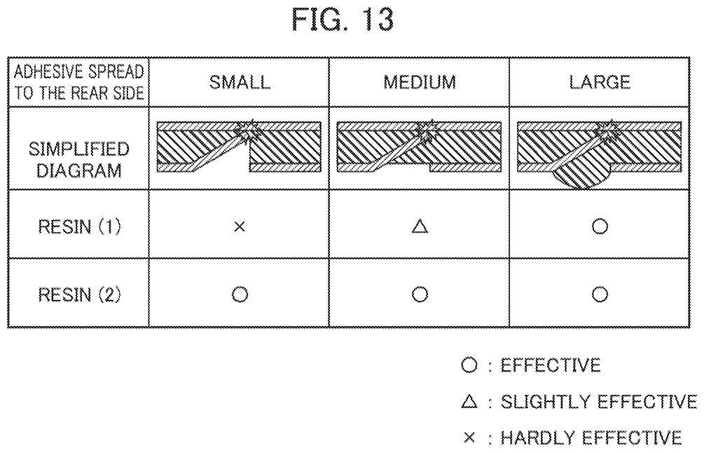

FIG. 13 is a table showing a correlation between the form of an adhesive used for forming the composite material of the embodiment of the present invention and the shock wave generated. FIG. 13 shows the results of experiments conducted on two resins (1) and (2) used as an adhesive insulator. In the column of “Adhesive spread to the rear side”, “small”, “medium”, and “large” indicate the amount of the adhesive reaching the gap 702 in the conductor plate 73 in the third form shown in the middle step in FIG. 2. The symbols of “cross (x)”, “triangle (Δ)”, and “circle (∘)” each indicate how much the adhesive was broken by the shock wave caused by the dielectric breakdown between the protruding end of the protrusion raised from the lower first conductor and the second conductor. The “cross” symbol indicates that the adhesive was hardly broken. The “triangle” symbol indicates that the adhesive was slightly broken. The “circle” symbol indicates that the adhesive was effectively broken. From the results of the resin (1) used as the insulator, it can be understood that the more adhesive reaches the gap 702 on the rear side of the protrusion, the more effectively the adhesive was broken.

The method of disassembling the composite material and composite material itself of the present embodiment have the following advantages.

The method of disassembling the composite material of aspect (1) includes: the protrusion formation step S1 of forming the protrusion 10 in a predefined part of the first conductor 7; the composite material formation step S2 of applying the insulator 9 to the surface of the first conductor 7 on which the protrusion 10 stands and bonding or joining the first conductor 7 and the second conductor 8 facing the protruding end 101 of the protrusion 10 with the insulator 9 to form the composite material 1; and the separation step S3 of applying the electric pulse between the first conductor 7 and the second conductor 8 to damage the insulator 9, thereby separating the first conductor 7 and the second conductor 8 from each other. Even if the composite material 1 is long and has multiple protrusions 10 along its length, the protrusions 10, which are elastic, maintain a suitable discharging gap between each of the protrusions 10 and the corresponding first or second conductor. When the shock wave of the dielectric breakdown current in the maintained discharging gap is uniformly generated at the protrusions 10 in the insulator 9, the insulator 9 is effectively broken, and the conductors (the first and second conductors 7 and 8) constituting the composite material 1 can be separated from each other.

In the method of aspect (2), the protrusion 10 is formed to widen from the protruding end 101 toward the proximal end 102 in the protrusion formation step S1. This protrusion 10 has high elasticity that keeps the protrusion 10 standing up at the proximal end 102, advantageously contributing to the control of the discharging gap. Further, the protruding end 102 in a tapered shape easily causes the dielectric breakdown between the protruding end 102 and the corresponding conductor (the first or second conductor 7 or 8).

In the method of aspect (3), the composite material formation step S2 includes the contacting step S221 of bringing the protruding end 101 of the protrusion 10 into contact with the insulating film 15 formed on the surface of a conductor used as the second conductor 8. Even if the composite material has multiple protrusions 10, the discharging gap between each of the protrusions 10 and the corresponding first or second conductor can be suitably controlled as the thickness of the insulating film 15.

The composite material 1 of aspect (4) is disassembled by the electric pulse. The composite material 1 includes: the elastic protrusion 10 formed on at least one of the first conductor 7 or the second conductor 8 to extend from its proximal end 102 to protruding end 101; and the insulator 9 that is applied to part of the first or second conductor 7 or 8 on which the protrusion 10 is formed and bonds or joins the first conductor 7 and the second conductor 8. Even if the composite material 1 is long and has multiple protrusions 10 along its length, the protrusions 10, which are elastic, maintain a suitable and uniform discharging gap between each of the protrusions 10 and the corresponding first or second conductor. When the shock wave of the dielectric breakdown current in the maintained discharging gap is uniformly generated at the protrusions 10 in the insulator 9, the insulator 9 is effectively broken, and the conductors constituting the composite material 1 can be separated from each other.

In the composite material of aspect (5), the protrusion 10 widens from the protruding end 101 toward the proximal end 102. This protrusion 10 has high elasticity that keeps the protrusion 10 standing up at the proximal end 102, advantageously contributing to the control of the discharging gap. Further, the protruding end 101 in a tapered shape easily causes the dielectric breakdown between the protruding end 101 and the corresponding conductor.

The composite material 1 of aspect (6) includes the insulating film 15 that is formed on at least the other of the first conductor 7 or the second conductor 8 and makes contact with the protruding end 101 of the protrusion 10. Thus, the discharging gap can be suitably controlled as the thickness of the insulating film 15.

The method of aspect (7) is the method of disassembling the composite material 1 including the first conductor 7 having the elastic protrusion 10 formed in a predefined part and the second conductor 8 facing the protruding end 101 of the protrusion 10, the first conductor 7 and the second conductor 8 being bonded or joined with the coating layer of the insulator 9 provided on the surface of the first conductor 7 on which the protrusion 10 stands. The method includes: the connection step S31 of electrically connecting the first conductor 7 and the second conductor 8 to the high voltage pulse generator 3 which is a predetermined electric pulse source; and the damage/separation step S32 of applying an electric pulse between the first conductor 7 and the second conductor 8 electrically connected to the high voltage pulse generator 3 in the connection step S31 to generate a shock wave of a dielectric breakdown current in the discharging gap between the protruding end 101 of the protrusion 10 and the second conductor 8, thereby damaging the insulator 9 to separate the first conductor 7 and the second conductor 8 from each other. Even if the composite material is long and has multiple protrusions 10 along its length, the protrusions 10, which are elastic, maintain a suitable discharging gap between each of the protrusions 10 and the corresponding first or second conductor. When the shock wave of the dielectric breakdown current in the maintained discharging gap is uniformly generated at the protrusions 10 in the insulator 9, the insulator 9 is effectively broken, and the conductors (the first and second conductors 7 and 8) constituting the composite material 1 can be separated from each other.

In the method of aspect (8), the protrusion 10 is widened from the protruding end 101 toward the proximal end 102. This protrusion 10 has high elasticity that keeps the protrusion 10 standing up at the proximal end 102, advantageously contributing to the control of the discharging gap. Further, the protruding end 101 in a tapered shape easily causes the dielectric breakdown between the protruding end 101 and the corresponding conductor.

In the method of aspect (9), the insulating film 15 is formed on the second conductor 8 and makes contact with the protrusion 10. Thus, the discharging gap can be suitably controlled as the thickness of the insulating film 15.

Embodiments of the present invention have just been described above, but the present invention is not limited to those exemplary embodiments. Details of the configuration may be altered within the spirit of the present invention. For example, the method of disassembling the composite material may be applied without holding the composite material with a holding device or any other device when applying the electric pulse to the composite material.

### EXPLANATION OF REFERENCE NUMERALS

1 Composite material
2 Holding device
3 High voltage pulse generator
4 Base
5 Stable holder
6 Movable holder
7 First conductor
8 Second conductor
9 Insulator
10, 10a, 10b, 10c Protrusion
11 Positive electrode cable
12 Positive electrode
13 Negative electrode cable
14 Negative electrode
15 Insulating film
16 Air
17 Insulator
18 Water
71 Conductor plate in first form
72 Conductor plate in second form
73 Conductor plate in third form
101, 101a, 101b, 101c Protruding end
102 Proximal end
701, 701a, 701b, 701c Cut
702 Gap

What is claimed is:

1. A method of disassembling a composite material, the method comprising: a protrusion formation step of forming an elastic protrusion in a predefined part of a first conductor;
a composite material formation step of applying an insulator to a surface of the first conductor on which the protrusion stands and bonding or joining the first conductor and a second conductor facing a protruding end of the protrusion with the insulator to form a composite material; and
a separation step of applying an electric pulse between the first conductor and the second conductor to damage the insulator, thereby separating the first conductor and the second conductor from each other.

2. The method of claim 1, wherein the protrusion is formed so as to widen from the protruding end toward a proximal end in the protrusion formation step.

3. The method of claim 1, wherein the composite material formation step includes a contacting step of bringing the protruding end of the protrusion into contact with an insulating film formed on a surface of a conductor used as the second conductor.

4. A composite material disassembled by an electric pulse, the composite material comprising:
an elastic protrusion formed on at least one of a first conductor or a second conductor to extend from its proximal end to protruding end; and
an insulator that is applied to part of the first or second conductor on which the protrusion is formed and bonds or joins the first conductor and the second conductor.

5. The composite material of claim 4, wherein the protrusion widens from the protruding end toward the proximal end.

6. The composite material of claim 4, further comprising: an insulating film that is formed on at least the other of the first conductor or the second conductor and makes contact with the protruding end of the protrusion.

7. A method of disassembling a composite material including a first conductor having an elastic protrusion formed in a predefined part and a second conductor facing a protruding end of the protrusion, the first conductor and the second conductor being bonded or joined with a coating layer of an insulator provided on a surface of the first conductor on which the protrusion stands, the method comprising:
a connection step of electrically connecting the first conductor and the second conductor to a predetermined electric pulse source; and
a separation step of applying an electric pulse between the first conductor and the second conductor electrically connected to the electric pulse source in the connection step to generate a shock wave of a dielectric breakdown current in a discharging gap between the protruding end of the protrusion and the second conductor, thereby damaging the insulator to separate the first conductor and the second conductor from each other.

8. The method of claim 7, wherein the protrusion widens from the protruding end toward a proximal end.

9. The method of claim 7, wherein an insulating film is formed on the second conductor and makes contact with the protrusion.
